(19) United States
(12) Patent Application Publication
(10) Pub. No.: US 2026/0148906 A1
(43) Pub. Date: May 28, 2026

(54) OPERATING MECHANISM FOR ELECTRIC SWITCH ASSEMBLY, AND ELECTRIC SWITCH ASSEMBLY COMPRISING THE SAME

(71) Applicant: ABB Schweiz AG, Baden (CH)

(72) Inventor: Alexander Jansson, Vaasa (FI)

(21) Appl. No.: 19/398,593

(22) Filed: Nov. 24, 2025

(30) Foreign Application Priority Data
Nov. 25, 2024 (EP) 24215133.0

(51) Int. Cl. H01H 9/26; H01H 3/04; H01H 9/00; H01H 9/22

(52) U.S. Cl. CPC H01H 9/26; H01H 3/04; H01H 9/22; H01H 2009/0094; H01H 2221/052; H01H 2225/01; H01H 2233/092; H01H 2233/102

(57) ABSTRACT

An operating mechanism for an electric switch assembly is described. The operating mechanism is configured to be operationally connected to a first electric switch and a second electric switch. The operating mechanism comprises a frame, an operating lever, a first link, a second link, a coupling system configured to selectively couple the second link to the first link, and an actuation system coupled to the first link and the second link for actuating an actuation lever of the first electric switch and an actuation lever of the second electric switch. The actuation system comprises a first actuation protrusion and a second actuation protrusion stationarily connected to the first link, and a third actuation protrusion and a fourth actuation protrusion stationarily connected to the second link.

### CROSS REFERENCE TO RELATED APPLICATIONS

The present application claims priority to European Patent Application No. EP, 24215133.0 filed on Nov. 25, 2024, and titled “OPERATING MECHANISM FOR ELECTRIC SWITCH ASSEMBLY, AND ELECTRIC SWITCH ASSEMBLY COMPRISING THE SAME”, which is hereby incorporated by reference in its entirety.

### TECHNICAL FIELD

The present disclosure relates to an operating mechanism for an electric switch assembly, and to an electric switch assembly comprising said operating mechanism. The operating mechanism of present disclosure is suitable for a Closed Transition Automatic Transfer Switch.

### BACKGROUND

A known CT ATS is adapted to be manually operated by two operating levers, and manual transfer between different operational states cannot be carried out under load.

### BRIEF DESCRIPTION

An object of the present disclosure is to provide an easy-to-use operating mechanism for a CT ATS assembly.

The objects of the present disclosure are achieved by an operating mechanism for an electric switch assembly and an electric switch assembly comprising the operating mechanism which are characterized by what is stated in the independent claims. Further exemplary embodiments are evident from the dependent claims and the following description. The embodiments and features, if any, described in this specification that do not fall under the scope of the independent claim are to be interpreted as examples useful for understanding various embodiments of the present disclosure.

An advantage of the electric switch assembly of the present disclosure is that it is adapted to be manually operated by means of single operating lever. Further, the operating mechanism of the present disclosure has a simple, fully mechanical structure.

### BRIEF DESCRIPTION OF DRAWINGS

The subject matter of the present disclosure will be explained in more detail in the following text with reference to exemplary embodiments which are illustrated in the attached drawings.

FIG. 1 shows an electric switch assembly according to an embodiment of the present disclosure.

FIG. 2 shows an exploded view of the electric switch assembly of FIG. 1.

FIG. 3 shows the electric switch assembly of FIG. 1 from another view angle.

FIG. 4 shows an exploded view of the electric switch assembly of FIG. 3.

FIGS. 5a to 10a are partially transparent side views of the electric switch assembly of FIG. 1 in different operational states.

FIGS. 5b to 10b are top views of the electric switch assembly of FIG. 1 in different operational states.

FIG. 11 shows an exploded view of an electric switch assembly according to another embodiment of the present disclosure.

FIG. 12 shows an exploded view of the electric switch assembly of FIG. 11 from another view angle.

The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

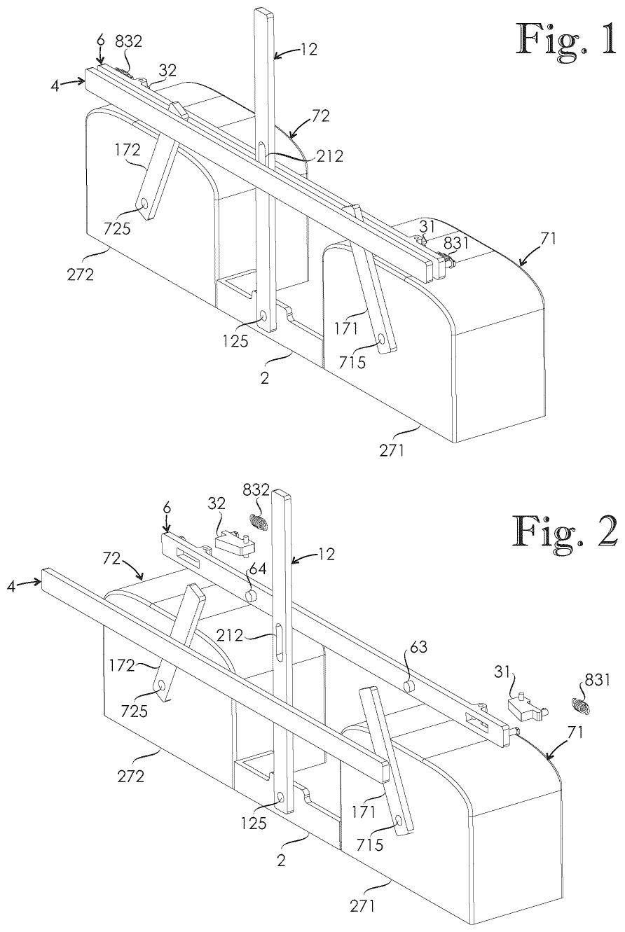

FIG. 1 shows an electric switch assembly comprising a first electric switch 71, a second electric switch 72, and an operating mechanism operationally connected to the first electric switch 71 and the second electric switch 72. FIG. 2 shows an exploded view of the electric switch assembly of FIG. 1.

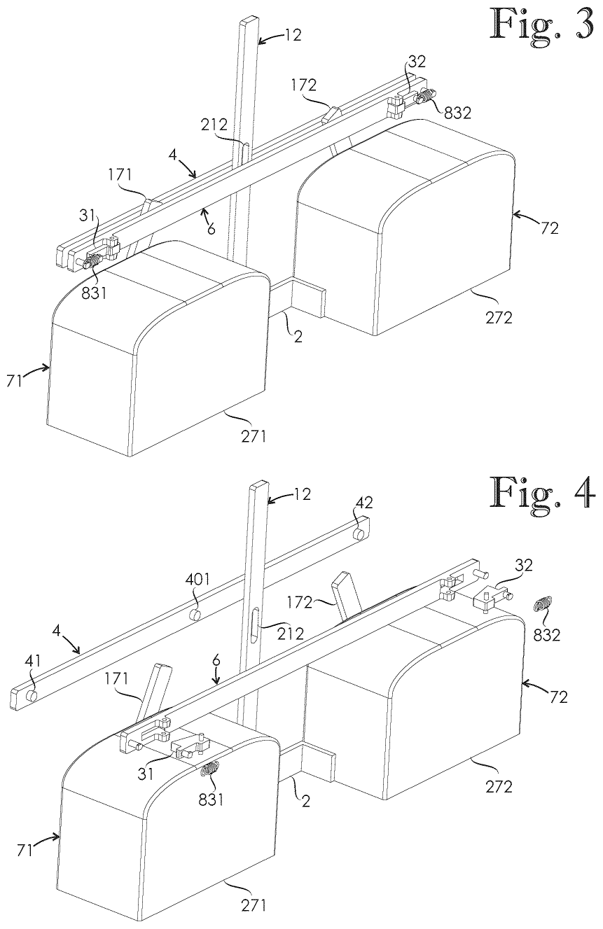

FIG. 3 shows the electric switch assembly of FIG. 1 from another view angle. FIG. 4 shows an exploded view of the electric switch assembly of FIG. 3.

The first electric switch 71 has a body part 271 and an actuation lever 171 rotatable relative to the body part 271 around a first switch axis 715 between a first position and a second position. The second electric switch 72 has a body part 272 and an actuation lever 172 rotatable relative to the body part 272 around a second switch axis 725 between a first position and a second position. The first positions of the actuation lever 171 and the actuation lever 172 correspond to disconnected positions or off-positions of the electric switches, and the second positions of the actuation lever 171 and the actuation lever 172 correspond to connected positions or on-positions of the electric switches.

Both the first electric switch 71 and the second electric switch 72 are provided with an intermediate state prevention system that is adapted to prevent the electric switch from stalling in an intermediate state between the disconnected position and the connected position.

The operating mechanism comprises a frame 2, an operating lever 12, a first link 4, a second link 6, a coupling system and an actuation system.

The body part 271 of the first electric switch 71 and the body part 272 of the second electric switch 72 are stationary relative to the frame 2.

The operating lever 12 is rotatable relative to the frame 2 around an operating lever axis 125 between a first position and a second position, wherein the operating lever 12 has a center position between the first position and the second position. The first switch axis 715 and the second switch axis 725 are parallel with the operating lever axis 125. The operating lever 12 is adapted to be manually moved between the first position and the second position.

All axes defined herein are axes of rotation. Different terms are used in order to distinguish different axes of rotation from each other. For conciseness, word “rotation” is omitted from the terms denoting the different axes of rotation.

In an alternative embodiment, the operating lever is movable relative to the frame between a first position and a second position, wherein the operating lever has a center position between the first position and the second position.

The first link 4 is movable relative to the frame 2 between a first position and a second position. The first link 4 has a center position between the first position and the second position. There is an operational connection between the first link 4 and the operating lever 12 such that movement of the operating lever 12 from the first position to the second position moves the first link 4 from the first position to the second position. The first link 4 is adapted to move with the operating lever 12 such that the position of the first link 4 corresponds to the position of the operating lever 12.

The operational connection between the operating lever 12 and the first link 4 comprises a lever coupling system adapted to transfer forces from the operating lever 12 to the first link 4 for moving the first link 4 between the first position and the second position, wherein the lever coupling system is spaced apart from the operating lever axis 125. The lever coupling system comprises a slot 212 provided in the operating lever 12, and a pin 401 stationarily connected to the first link 4, wherein the slot 212 extends in a direction perpendicular to the operating lever axis 125, and the pin 401 is received in the slot 212.

The second link 6 is movable relative to the frame 2 between a first position and a second position. The second link 6 has a center position between the first position and the second position.

The first link 4 and the second link 6 are adapted to move linearly relative to the frame 2. The first link 4 and the second link 6 are adapted to move parallel to each other. Both the first link 4 and the second link 6 are adapted to move in a longitudinal direction perpendicular to the operating lever axis 125.

In an embodiment, the operating mechanism comprises a support system adapted to support and guide the first link and the second link. The support system is stationary relative to the frame. For example, the operating mechanism shown in FIG. 1 could be provided with a support system adapted to support and guide the first link 4 and the second link 6 such that only movement in the longitudinal direction is allowed for the first link 4 and the second link 6.

The first switch axis 715 and the second switch axis 725 are spaced apart in the longitudinal direction. The operating lever axis 125 is located between the first switch axis 715 and the second switch axis 725 in the longitudinal direction.

In an alternative embodiment, the first link and the second link are adapted to move substantially linearly relative to the frame such that rotation angles of the first link and the second link relative to the frame are less than rotation angle of the operating lever.

In a lateral direction parallel to the operating lever axis 125, the operating lever 12 is located between the first link 4 and the second link 6. In the lateral direction, the operating mechanism is adapted to receive the actuation lever 171 and the actuation lever 172 between the first link 4 and the second link 6.

The coupling system is adapted to selectively couple the second link 6 to the first link 4. The coupling system comprises a first coupling member 31, a second coupling member 32, a first return member 831 and a second return member 832.

The first coupling member 31 is movable between a coupling position and a decoupling position relative to the second link 6 such that in the coupling position the first coupling member 31 is adapted to operationally connect the first link 4 to the second link 6 such that movement of the first link 4 from the center position to the second position moves the second link 6 from the center position to the second position. The second coupling member 32 is movable between a coupling position and a decoupling position relative to the second link 6 such that in the coupling position the second coupling member 32 is adapted to operationally connect the first link 4 to the second link 6 such that movement of the first link 4 from the center position to the first position moves the second link 6 from the center position to the first position. In the decoupling positions, the first coupling member 31 and the second coupling member 32 are adapted to allow free movement between the first link 4 and the second link 6.

The first coupling member 31 is movable between the coupling position and the decoupling position by rotation about a first coupling member axis. The first coupling member axis is perpendicular to both the longitudinal direction and the lateral direction. The second coupling member 32 is movable between the coupling position and the decoupling position by rotation about a second coupling member axis. The second coupling member axis is perpendicular to both the longitudinal direction and the lateral direction. The second coupling member axis is spaced apart from the first coupling member axis.

In an alternative embodiment, both the first coupling member and the second coupling member are movable between the coupling position and the decoupling position relative to the second link by a linear motion relative to the second link.

The first return member 831 is operationally connected to the first coupling member 31 for returning the first coupling member 31 to the coupling position if the first coupling member 31 is deflected from the coupling position towards the decoupling position. The second return member 832 is operationally connected to the second coupling member 32 for returning the second coupling member 32 to the coupling position if the second coupling member 32 is deflected from the coupling position towards the decoupling position.

In the center position of the second link 6, the first coupling member 31 is adapted to be moved from the coupling position to the decoupling position by movement of the actuation lever 171 of the first electric switch 71 from the first position to the second position, and the second coupling member 32 is adapted to be moved from the coupling position to the decoupling position by movement of the actuation lever 172 of the second electric switch 72 from the first position to the second position.

The first return member 831 and the second return member 832 are extension springs. In an alternative embodiment, the first return member and the second return member are different type of springs such as torsion springs or pressure springs. In a further alternative embodiment, the first return member and the second return member are elastic members.

The actuation system is coupled to the first link 4 and the second link 6 for actuating the actuation lever 171 of the first electric switch 71 and the actuation lever 172 of the second electric switch 72. The actuation system comprises a first actuation protrusion 41, a second actuation protrusion 42, a third actuation protrusion 63 and a fourth actuation protrusion 64. The first actuation protrusion 41 and the third actuation protrusion 63 are adapted to cooperate with the actuation lever 171 of the first electric switch 71, and the second actuation protrusion 42 and the fourth actuation protrusion 64 are adapted to cooperate with the actuation lever 172 of the second electric switch 72.

The first actuation protrusion 41 and the second actuation protrusion 41 are stationarily connected to the first link 4. The first actuation protrusion 41 and the second actuation protrusion 42 protrude from the first link 4 towards the second link 6 in the lateral direction. In the longitudinal direction, the first actuation protrusion 41 and the second actuation protrusion 42 are spaced apart from each other. In the coupling position, the first coupling member 31 is adapted to cooperate with the first actuation protrusion 41 for moving the second link 6 from the center position to the second position. In the coupling position, the second coupling member 32 is adapted to cooperate with the second actuation protrusion 42 for moving the second link 6 from the center position to the first position.

The third actuation protrusion 63 and the fourth actuation protrusion 64 are stationarily connected to the second link 6. The third actuation protrusion 63 and the fourth actuation protrusion 64 protrude from the second link 6 towards the first link 4 in the lateral direction. In the longitudinal direction, the third actuation protrusion 63 and the fourth actuation protrusion 64 are spaced apart from each other. A distance between the third actuation protrusion 63 and the fourth actuation protrusion 64 is less than a distance between the first actuation protrusion 41 and the second actuation protrusion 42.

The actuation system is adapted to actuate the actuation levers such that movement of the first link 4 from the center position to the first position is adapted to move the actuation lever 172 of the second electric switch 72 from the second position to the first position; movement of the first link 4 from the center position to the second position is adapted to move the actuation lever 171 of the first electric switch 71 from the second position to the first position; movement of the second link 6 from the center position to the first position is adapted to move the actuation lever 171 of the first electric switch 71 from the first position to the second position; and movement of the second link 6 from the center position to the second position is adapted to move the actuation lever 172 of the second electric switch 72 from the first position to the second position.

The electric switch assembly is adapted to be switched to three separate operational states by moving the operating lever 12, wherein the three separate operational states are a first state in which the first electric switch 71 is in the connected position and the second electric switch 72 is in the disconnected position; a second state in which the first electric switch 71 is in the disconnected position and the second electric switch 72 is in the connected position; and a third state in which both the first electric switch 71 and the second electric switch 72 are in the disconnected positions. The operating mechanism of the electric switch assembly is adapted to prevent transferring the electric switch assembly to a fourth state by moving the operating lever 12, wherein the fourth state is a state in which both the first electric switch 71 and the second electric switch 72 are in the connected positions.

It should be noted that the operating mechanism shown in FIGS. 1 to 10 is not adapted to completely prevent transferring the electric switch assembly to the fourth state but only to prevent transferring the electric switch assembly to the fourth state by moving the operating lever 12. In fact, the operating mechanism shown in FIGS. 1 to 10 is adapted to allow transferring the electric switch assembly to the fourth state.

In an embodiment, the operating mechanism comprises an electric actuator system adapted to transfer the electric switch assembly to the fourth state.

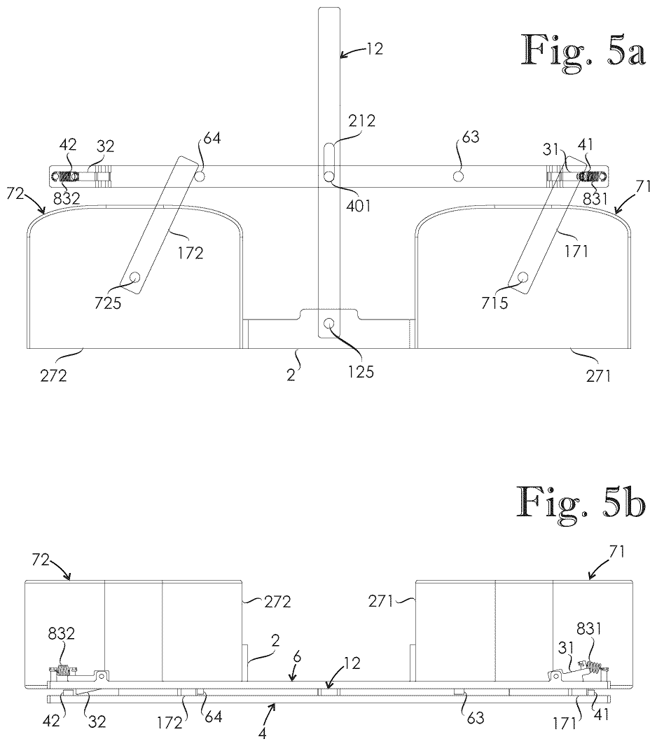

FIG. 5a is a partially transparent side view of the electric switch assembly of FIG. 1 in the first state in which the first electric switch 71 is in the connected position, the second electric switch 72 is in the disconnected position and the operating lever 12 is in the center position. FIG. 5b is a top view of the electric switch assembly of FIG. 1 in the first state.

In the side views, the first positions of the first link 4 and the second link 6 are to the right from the center positions, the first position of the operating lever 12 is clockwise from the center position such that a free end of the operating lever 12 is to the right from the center position, the longitudinal direction is a horizontal direction, and the lateral direction is perpendicular to the image plane.

In the first state, the first coupling member 31 is in the decoupling position while the second coupling member 32 is in the coupling position. FIGS. 5a and 5b show that the actuation lever 171 of the first electric switch 71 is in contact with the first coupling member 31 such that the actuation lever 171 keeps the first coupling member 31 in the decoupling position. In the first state, the actuation lever 171 of the first electric switch 71 exerts forces to the first coupling member 31, wherein said forces are parallel to the operating lever axis 125, and act as counterforces for forces exerted to the first coupling member 31 by the first return member 831. The actuation lever 172 of the second electric switch 72 is not in contact with the second coupling member 32 thereby allowing the second coupling member 32 to be in the coupling position.

Herein, the partially transparent side view is a view in which the operating lever 12, the first link 4, the second link 6, the actuation lever 171 of the first electric switch 71 and the actuation lever 172 of the second electric switch 72 are depicted as transparent components in order to better illustrate interaction between different components.

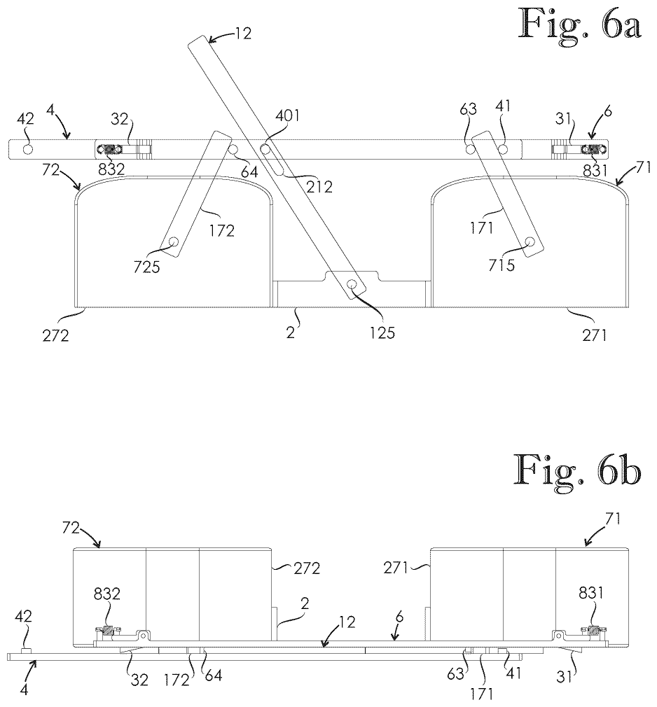

FIG. 6a is a partially transparent side view of the electric switch assembly of FIG. 1 in a first intermediate state between the first state and the third state. FIG. 6b is a top view of the electric switch assembly of FIG. 1 in the first intermediate state. In the first intermediate state, both the first electric switch 71 and the second electric switch 72 are in the disconnected positions, and the operating lever 12 is in the second position. The first link 4 is in the second position. The electric switch assembly is adapted to be transferred from the first state to the first intermediate state by rotating the operating lever 12 from the middle to the left.

In the first intermediate state, both the first coupling member 31 and the second coupling member 32 are in the coupling positions. The actuation lever 171 of the first electric switch 71 is not in contact with the first coupling member 31 and therefore the first return member 831 has returned the first coupling member 31 into the coupling position.

FIGS. 6a and 6b show that the electric switch assembly has been transferred from the first state to the first intermediate state through forces exerted by the first actuation protrusion 41 to the actuation lever 171 of the first electric switch 71. During the transfer from the first state to the first intermediate state, the second link 6 remains in the center position since the decoupling position of the first coupling member 31 allowed free movement between the first link 4 and the second link 6.

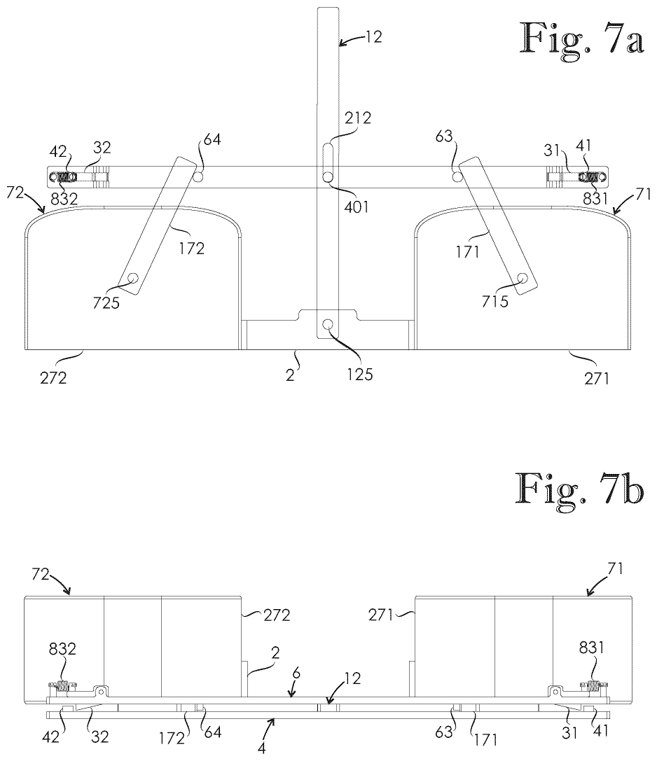

FIG. 7a is a partially transparent side view of the electric switch assembly of FIG. 1 in the third state in which both the first electric switch 71 and the second electric switch 72 are in the disconnected position, and the operating lever 12 is in the center position. The first link 4 and the second link 6 are in the center positions. FIG. 7b is a top view of the electric switch assembly of FIG. 1 in the third state.

The electric switch assembly is adapted to be transferred from the first intermediate state to the third state by rotating the operating lever 12 from the left to the middle. During the transfer from the first intermediate state to the third state, the second link 6 remains in the center position since the coupling system allows free movement between the first link 4 and the second link 6. In the third state, both the first coupling member 31 and the second coupling member 32 are in the coupling positions.

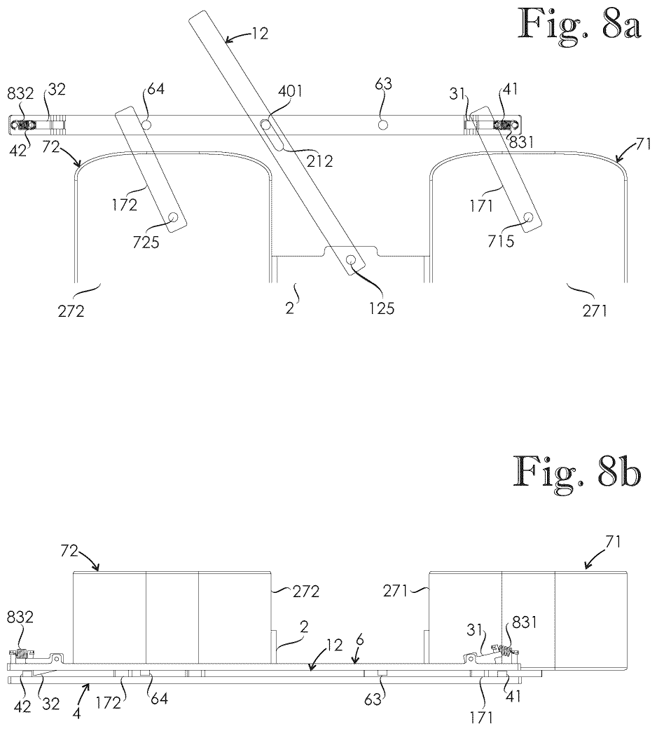

FIG. 8a is a partially transparent side view of the electric switch assembly of FIG. 1 in a second intermediate state between the third state and the second state. FIG. 8b is a top view of the electric switch assembly of FIG. 1 in the second intermediate state. In the second intermediate state, the first electric switch 71 is in the disconnected position, the second electric switch 72 is in the connected position, and the operating lever 12 is in the second position. The first link 4 and the second link 6 are in the second positions.

In the second intermediate state, the first coupling member 31 is in the decoupling position while the second coupling member 32 is in the coupling position. FIGS. 8a and 8b show that the actuation lever 171 of the first electric switch 71 is in contact with the first coupling member 31 such that the actuation lever 171 keeps the first coupling member 31 in the decoupling position. The actuation lever 172 of the second electric switch 72 is not in contact with the second coupling member 32 thereby allowing the second coupling member 32 to be in the decoupling position.

The electric switch assembly is adapted to be transferred from the third state to the second intermediate state by rotating the operating lever 12 from the middle to the left. FIGS. 8a and 8b show that the electric switch assembly has been transferred from the third state to the second intermediate state through forces exerted by the fourth actuation protrusion 64 to the actuation lever 172 of the second electric switch 72. During the transfer from the third state to the second intermediate state, the first coupling member 31 is in the coupling position and therefore the second link 6 is operationally connected with the first link 4 and moves with it to the second position since the first actuation protrusion 41 exert forces to the first coupling member 31.

In connection with the electric switch assembly arriving to the second intermediate state, the first coupling member 31 transfers to the decoupling position since the actuation lever 171 of the first electric switch 71 comes into contact with the first coupling member 31 and presses the first coupling member 31 into the decoupling position. The second coupling member 32 remains in the coupling position during the entire transition from the third state to the second intermediate state since the actuation lever 172 of the second electric switch 72 is not in contact with the second coupling member 32 thereby allowing the second coupling member 32 to be in the coupling position.

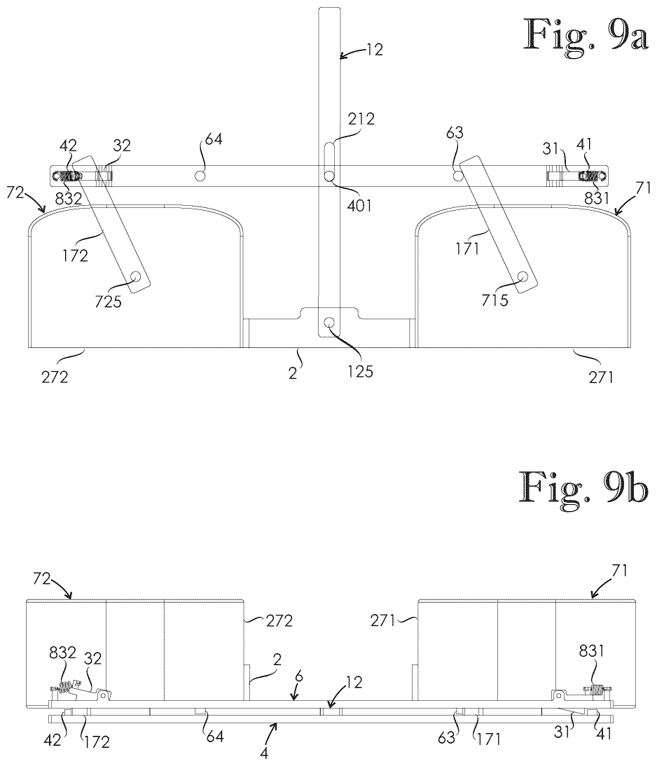

FIG. 9a is a partially transparent side view of the electric switch assembly of FIG. 1 in the second state in which the first electric switch 71 is in the disconnected position, the second electric switch 72 is in the connected position and the operating lever 12 is in the center position. The first link 4 and the second link 6 are in the center positions. FIG. 9b is a top view of the electric switch assembly of FIG. 1 in the second state. The electric switch assembly is adapted to be transferred from the second intermediate state to the second state by rotating the operating lever 12 from the left to the middle.

In the beginning of the transfer of the electric switch assembly from the second intermediate state towards the second state, the first coupling member 31 transfers from the decoupling position to the coupling position since the actuation lever 171 of the first electric switch 71 loses contact with the first coupling member 31 thereby allowing the first coupling member 31 to transfer to the coupling position through forces exerted by the first return member 831.

In connection with the electric switch assembly arriving to the second state from the second intermediate state, the second coupling member 32 transfers to the decoupling position since the actuation lever 172 of the second electric switch 72 comes into contact with the second coupling member 32 and presses the second coupling member 32 into the decoupling position.

FIGS. 9a and 9b show that the actuation lever 172 of the second electric switch 72 is in contact with the second coupling member 32 such that the actuation lever 172 keeps the second coupling member 32 in the decoupling position. In the second state, the actuation lever 172 of the second electric switch 72 exerts forces to the second coupling member 32, wherein said forces are parallel to the operating lever axis 125, and act as counterforces for forces exerted to the second coupling member 32 by the second return member 832. The first coupling member 31 is in the coupling position since the actuation lever 171 of the first electric switch 71 is not in contact with the first coupling member 31.

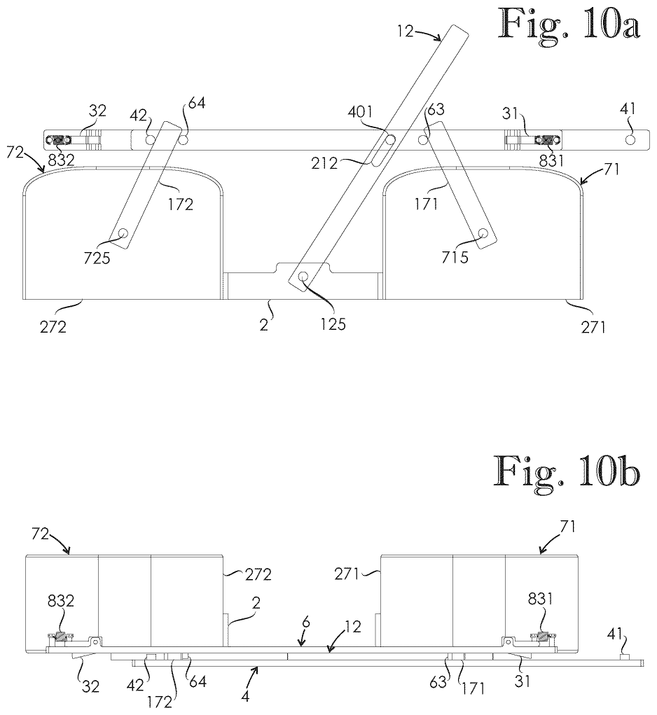

FIG. 10a is a partially transparent side view of the electric switch assembly of FIG. 1 in a third intermediate state between the second state and the third state. FIG. 10b is a top view of the electric switch assembly of FIG. 1 in the third intermediate state. In the third intermediate state, both the first electric switch 71 and the second electric switch 72 are in the disconnected position, and the operating lever 12 is in the first position. The first link 4 is in the first position and the second link 6 is in the center position. The electric switch assembly is adapted to be transferred from the second state to the third intermediate state by rotating the operating lever 12 from the middle to the right.

In the third intermediate state, both the first coupling member 31 and the second coupling member 32 are in the coupling positions. The actuation lever 171 of the first electric switch 71 is not in contact with the first coupling member 31 and therefore the first coupling member 31 remains in the coupling position. The actuation lever 172 of the second electric switch 72 is not in contact with the second coupling member 32 and therefore the second return member 832 has returned the second coupling member 32 into the coupling position.

FIGS. 10a and 10b show that the electric switch assembly has been transferred from the second state to the third intermediate state through forces exerted by the second actuation protrusion 42 to the actuation lever 172 of the second electric switch 72. During the transfer from the second state to the third intermediate state, the second link 6 remains in the center position since in the beginning of the transfer from the second state to the third intermediate state, the decoupling position of the second coupling member 32 allowed free movement between the first link 4 and the second link 6, and after the second actuation protrusion 42 has moved past a coupling surface of the second coupling member 32 in the longitudinal direction, the second actuation protrusion 42 cannot cooperate with the second coupling member 32 anymore during the movement of the first link 4 towards the first position thereof.

A coupling surface of a coupling member is a surface adapted to be in contact with a corresponding actuation protrusion for moving a corresponding link. A coupling surface of the first coupling member 31 is adapted to be in contact with the first actuation protrusion 41 for moving the second link 6 from the center position to the second position. The coupling surface of the second coupling member 32 is adapted to be in contact with the second actuation protrusion 42 for moving the second link 6 from the center position to the first position.

In the longitudinal direction, the coupling surface of the first coupling member 31 is located farther from the operating lever axis 125 than the first coupling member axis, and the coupling surface of the second coupling member 32 is located farther from the operating lever axis 125 than the second coupling member axis.

The electric switch assembly is adapted to be transferred from the third intermediate state to the third state by rotating the operating lever 12 from the right to the middle. The third state is shown in FIG. 7a, and it has been discussed above.

In the embodiment shown in FIGS. 1 to 10, the first link 4 is adapted to operate as a pull link for pulling free ends of the actuation levers 171 and 172 towards the operating lever axis 125 in the longitudinal direction. The second link 6 is adapted to operate as a push link for pushing free ends of the actuation levers 171 and 172 away from the operating lever axis 125 in the longitudinal direction. The first electric switch 71 and the second electric switch 72 are operationally connected to the operating mechanism such that in the first positions, the free ends of the actuation levers 171 and 172 are closer to the operating lever axis 125 in the longitudinal direction than in the second positions.

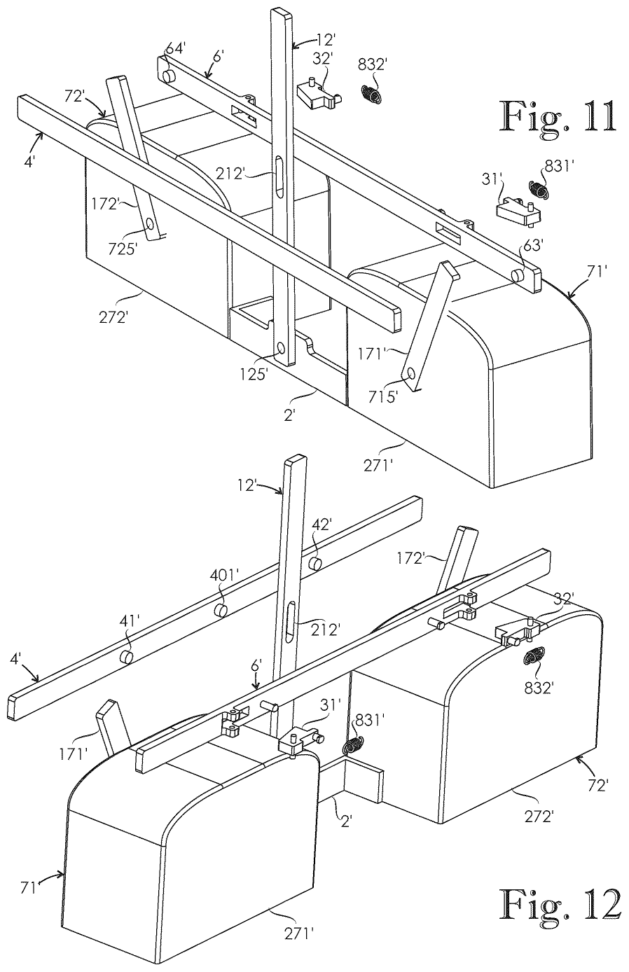

FIG. 11 shows an exploded view of an electric switch assembly according to another embodiment of the present disclosure. FIG. 12 shows an exploded view of the electric switch assembly of FIG. 11 from another view angle.

The electric switch assembly of FIG. 11 is adapted to be switched to the three separate operational states as the electric switch assembly of FIG. 1, and to prevent transferring the electric switch assembly to the fourth state by moving the operating lever as the electric switch assembly of FIG. 1.

The operating mechanism of FIG. 11 comprises the same components as the operating mechanism of FIG. 1, but components of the coupling system and the actuation system are located differently and therefore they are also adapted to operate differently. Differences between the coupling systems and the actuation systems of FIGS. 1 and 11 are discussed briefly below.

In the embodiment shown in FIG. 11, the first link 4′ is adapted to operate as a push link for pushing free ends of the actuation levers 171′ and 172′ away from the operating lever axis 125′ in the longitudinal direction. The second link 6′ is adapted to operate as a pull link for pulling free ends of the actuation levers 171′ and 172′ towards the operating lever axis 125′ in the longitudinal direction. A distance between the third actuation protrusion 63′ and the fourth actuation protrusion 64′ is greater than a distance between the first actuation protrusion 41′ and the second actuation protrusion 42′.

In the longitudinal direction, the coupling surface of the first coupling member 31′ is located closer to the operating lever axis 125′ than the first coupling member axis, and the coupling surface of the second coupling member 32′ is located closer to the operating lever axis 125′ than the second coupling member axis.

In the electric switch assembly of FIG. 11, the first electric switch 71′ and the second electric switch 72′ are operationally connected to the operating mechanism such that in the first positions, the free ends of the actuation levers 171′ and 172′ are further from the operating lever axis 125′ in the longitudinal direction than in the second positions.

Both the electric switch assembly of FIG. 1 and the electric switch assembly of FIG. 11 are adapted to be manually operated under load.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the present disclosure, from a study of the drawings, the disclosure, and the appended claims. In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An operating mechanism for an electric switch assembly, the operating mechanism configured to be operationally connected to a first electric switch having an actuation lever and a second electric switch having an actuation lever, wherein each of the actuation lever of the first electric switch and the actuation lever of the second electric switch has a first position and a second position, the operating mechanism comprising:
a frame;
an operating lever movable relative to the frame between a first position and a second position, wherein the operating lever has a center position between the first position and the second position;
a first link movable relative to the frame between a first position and a second position, wherein the first link has a center position between the first position and the second position, and there is an operational connection between the first link and the operating lever such that movement of the operating lever from the first position to the second position moves the first link from the first position to the second position;
a second link movable relative to the frame between a first position and a second position, wherein the second link has a center position between the first position and the second position;
a coupling system configured to selectively couple the second link to the first link, wherein the coupling system comprises a first coupling member and a second coupling member, wherein the first coupling member is movable between a coupling position and a decoupling position such that in the coupling position the first coupling member is configured to operationally connect the first link to the second link such that movement of the first link from the center position to the second position moves the second link from the center position to the second position, wherein the second coupling member is movable between a coupling position and a decoupling position such that in the coupling position the second coupling member is configured to operationally connect the first link to the second link such that movement of the first link from the center position to the first position moves the second link from the center position to the first position, and wherein in the decoupling position, the first coupling member and the second coupling member are configured to allow free movement between the first link and the second link;
an actuation system coupled to the first link and the second link for actuating the actuation lever of the first electric switch and the actuation lever of the second electric switch, wherein the actuation system comprises a first actuation protrusion and a second actuation protrusion stationarily connected to the first link, and a third actuation protrusion and a fourth actuation protrusion stationarily connected to the second link,
wherein the actuation system is configured to actuate the actuation levers such that when the operating mechanism is operationally connected to the first electric switch and the second electric switch, the electric switch assembly is configured to be switched to three separate operational states by moving the operating lever, and wherein the three separate operational states comprise:
a first operational state in which the first electric switch is in the second position and the second electric switch is in the first position;
a second operational state in which the first electric switch is in the first position and the second electric switch is in the second position; and
a third operational state in which both the first electric switch and the second electric switch are in the first positions,
wherein the operating mechanism of the electric switch assembly is configured to prevent transferring the electric switch assembly to a fourth operational state by moving the operating lever, and wherein the fourth operational state is an operational state in which both the first electric switch and the second electric switch are in the second positions.

2. The operating mechanism as claimed in claim 1, wherein the first link and the second link are configured to move linearly relative to the frame.

3. The operating mechanism as claimed in claim 1, wherein the coupling system comprises a first return member and a second return member, and wherein the first return member is operationally connected to the first coupling member for returning the first coupling member to the coupling position if the first coupling member is deflected from the coupling position towards the decoupling position, and the second return member is operationally connected to the second coupling member for returning the second coupling member to the coupling position if the second coupling member is deflected from the coupling position towards the decoupling position.

4. The operating mechanism as claimed in claim 1, wherein in the center position of the second link, the first coupling member is configured to be moved from the coupling position to the decoupling position by movement of the actuation lever of the first electric switch from the first position to the second position, and the second coupling member is configured to be moved from the coupling position to the decoupling position by movement of the actuation lever of the second electric switch from the first position to the second position.

5. The operating mechanism as claimed in claim 1, wherein in the coupling position, the first coupling member is configured to cooperate with the first actuation protrusion, and wherein in the coupling position, the second coupling member is configured to cooperate with the second actuation protrusion.

6. The operating mechanism as claimed in claim 1, wherein the first actuation protrusion and the third actuation protrusion are configured to cooperate with the actuation lever of the first electric switch, and the second actuation protrusion and the fourth actuation protrusion are configured to cooperate with the actuation lever of the second electric switch.

7. The operating mechanism as claimed in claim 1, wherein the operating lever is rotatable relative to the frame around an operating lever axis, and
wherein the operational connection between the operating lever and the first link comprises a lever coupling system configured to transfer forces from the operating lever to the first link for moving the first link between the first position and the second position, and wherein the lever coupling system is spaced apart from the operating lever axis.

8. The operating mechanism as claimed in claim 7, wherein the lever coupling system comprises a slot provided in the operating lever, and a pin stationarily connected to the first link, and wherein the slot extends in a direction perpendicular to the operating lever axis, and the pin is received in the slot.

9. The operating mechanism as claimed in claim 1, wherein the operating lever is configured to be manually moved between the first position and the second position.

10. An electric switch assembly comprising:
a first electric switch:
a second electric switch;
an operating mechanism configured to be operationally connected to the first electric switch having an actuation lever and the second electric switch having an actuation lever, wherein each of the actuation lever of the first electric switch and the actuation lever of the second electric switch has a first position and a second position, the operating mechanism comprising:
a frame;
an operating lever movable relative to the frame between a first position and a second position, wherein the operating lever has a center position between the first position and the second position;
a first link movable relative to the frame between a first position and a second position, wherein the first link has a center position between the first position and the second position, and there is an operational connection between the first link and the operating lever such that movement of the operating lever from the first position to the second position moves the first link from the first position to the second position;
a second link movable relative to the frame between a first position and a second position, wherein the second link has a center position between the first position and the second position;
a coupling system configured to selectively couple the second link to the first link, wherein the coupling system comprises a first coupling member and a second coupling member, wherein the first coupling member is movable between a coupling position and a decoupling position such that in the coupling position the first coupling member is configured to operationally connect the first link to the second link such that movement of the first link from the center position to the second position moves the second link from the center position to the second position, wherein the second coupling member is movable between a coupling position and a decoupling position such that in the coupling position the second coupling member is configured to operationally connect the first link to the second link such that movement of the first link from the center position to the first position moves the second link from the center position to the first position, and wherein in the decoupling position, the first coupling member and the second coupling member are configured to allow free movement between the first link and the second link;
an actuation system coupled to the first link and the second link for actuating the actuation lever of the first electric switch and the actuation lever of the second electric switch, wherein the actuation system comprises a first actuation protrusion and a second actuation protrusion stationarily connected to the first link, and a third actuation protrusion and a fourth actuation protrusion stationarily connected to the second link,
wherein the actuation system is configured to actuate the actuation levers such that when the operating mechanism is operationally connected to the first electric switch and the second electric switch, the electric switch assembly is configured to be switched to three separate operational states by moving the operating lever, and wherein the three separate operational states comprise:
a first operational state in which the first electric switch is in the second position and the second electric switch is in the first position;
a second operational state in which the first electric switch is in the first position and the second electric switch is in the second position; and
a third operational state in which both the first electric switch and the second electric switch are in the first positions, and
wherein the operating mechanism of the electric switch assembly is configured to prevent transferring the electric switch assembly to a fourth operational state by moving the operating lever, and wherein the fourth operational state is an operational state in which both the first electric switch and the second electric switch are in the second positions.

11. The electric switch assembly as claimed in claim 10, wherein the operating mechanism is operationally connected to the first electric switch and the second electric switch such that the first positions of both the first electric switch and the second electric switch are disconnected positions, and the second positions of both the first electric switch and the second electric switch are connected positions, wherein the electric switch assembly is configured to be switched to three separate operational states by moving the operating lever, wherein the three separate operational states comprise:
a first operational state in which the first electric switch is in the connected position and the second electric switch is in the disconnected position;
a second operational state in which the first electric switch is in the disconnected position and the second electric switch is in the connected position; and
a third operational state in which both the first electric switch and the second electric switch are in the disconnected positions,
wherein the operating mechanism of the electric switch assembly is configured to prevent transferring the electric switch assembly to a fourth operational state by moving the operating lever, and wherein the fourth operational state is an operational state in which both the first electric switch and the second electric switch are in the connected positions.

12. The electric switch assembly as claimed in claim 11, wherein both the first electric switch and the second electric switch are provided with an intermediate state prevention system that is configured to prevent the first and second electric switches from stalling in an intermediate operational position between the disconnected position and the connected position.

13. The electric switch assembly as claimed in claim 10, wherein the first link and the second link are configured to move linearly relative to the frame.

14. The electric switch assembly as claimed in claim 10, wherein the coupling system comprises a first return member and a second return member, and wherein the first return member is operationally connected to the first coupling member for returning the first coupling member to the coupling position if the first coupling member is deflected from the coupling position towards the decoupling position, and the second return member is operationally connected to the second coupling member for returning the second coupling member to the coupling position if the second coupling member is deflected from the coupling position towards the decoupling position.

15. The electric switch assembly as claimed in claim 10, wherein in the center position of the second link, the first coupling member is configured to be moved from the coupling position to the decoupling position by movement of the actuation lever of the first electric switch from the first position to the second position, and the second coupling member is configured to be moved from the coupling position to the decoupling position by movement of the actuation lever of the second electric switch from the first position to the second position.

16. The electric switch assembly as claimed in claim 10, wherein in the coupling position, the first coupling member is configured to cooperate with the first actuation protrusion, and wherein in the coupling position, the second coupling member is configured to cooperate with the second actuation protrusion.

17. The electric switch assembly as claimed in claim 10, wherein the first actuation protrusion and the third actuation protrusion are configured to cooperate with the actuation lever of the first electric switch, and the second actuation protrusion and the fourth actuation protrusion are configured to cooperate with the actuation lever of the second electric switch.

18. The electric switch assembly as claimed in claim 10, wherein:
the operating lever is rotatable relative to the frame around an operating lever axis, and
the operational connection between the operating lever and the first link comprises a lever coupling system configured to transfer forces from the operating lever to the first link for moving the first link between the first position and the second position, and wherein the lever coupling system is spaced apart from the operating lever axis.

19. The electric switch assembly as claimed in claim 18, wherein the lever coupling system comprises a slot provided in the operating lever, and a pin stationarily connected to the first link, and wherein the slot extends in a direction perpendicular to the operating lever axis, and the pin is received in the slot.

20. The electric switch assembly as claimed in claim 10, wherein the operating lever is configured to be manually moved between the first position and the second position.
